(19) United States
(12) Patent Application Publication
(10) Pub. No.: US 2009/0045058 A1
(43) Pub. Date: Feb. 19, 2009

(54) MICROCHIP AND ANALYSIS METHOD USING THE MICROCHIP

(75) Inventors: Machiko Fujita, Tokyo (JP); Hisao Kawaura, Tokyo (JP); Wataru Hattori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku (JP)

(21) Appl. No.: 12/097,479

(22) PCT Filed: Dec. 12, 2006
(86) PCT No.: PCT/JP2006/324725

§ 371 Date: Jun. 13, 2008

(30) Foreign Application Priority Data
Dec. 14, 2005 (JP) 2005-360172

(51) Int. Cl. G01N 27/26; B01J 19/00

(52) U.S. Cl. 204/451; 422/68.1

(57) ABSTRACT

With the object of realizing a microchip that allows drying and fixing of a substance that is the object of analysis in a shorter time while maintaining the separation capabilities of a separation operation, a microchip used to implement a separation operation of an analysis sample without contamination or spillage is composed of a substrate and a cover, the substrate being provided with a trench-shaped channel in its upper surface and substrate reservoirs that are linked with this channel, and the cover hermetically sealing the upper surface of the channel, attachable to or detachable from the substrate, and provided with through-holes formed at positions corresponding to the substrate reservoirs, cover reservoirs that are formed on the inner sides of the through-holes for holding liquid that is introduced when the cover is in the state of hermetically sealing the upper surface of the channel, and partitions that are formed on the bottom surfaces of the cover reservoirs. The areas of the openings of the partitions are smaller than the areas of the openings of the cover reservoirs that are over the partitions.

### TECHNICAL FIELD

The present invention relates to a microchip for use in biochemical analysis and to an analyzing method of using the microchip to analyze samples that contain biological/chemical substances.

The microchip for use in bio/chemical analyses and the sample analysis method that uses the microchip according to the present invention can be used for improving the reproducibility of further biochemical analyses that use analysis samples that have been separated on the microchip, such as sample analysis processes for mass spectrometry or bio-assay analyses.

### BACKGROUND ART

Regarding samples to be analyzed that contain biological substances and chemical substances that are to be subjected to analysis, various types of electrophoresis, chromatography, bio-assays and chemical assays are used when analyzing and identifying the substances that are the objects of analysis. In these analysis methods, the separation and measurement of bio-reactivity and chemical reactivity of samples are carried out in capillary tubes and well plates.

When the quantity of a sample is limited or when temperature control is necessary, it is advantageous to use a microchip in which channels of small capacity are integrated by micro-processing and in which only a small area is subjected to temperature control.

A microchip is an element having a substrate in which a trench-shaped channel has been formed on an upper surface of a desired planar shape and in which a cover for this channel are combined together in a prescribed arrangement and then bonded or secured. A method in which this channel is used for carrying out electrophoresis, chromatography, bio-assay, or chemical assay is proposed in Non-Patent Document 1 (Hong, J. W. et al., Electrophoresis, Vol. 22, 328-333 (2001)).

The microchip is of a configuration in which a cover composed of polydimethylsiloxane (PDMS), which is an elastic silicone resin, is bonded to a substrate composed of glass. A channel construction and a through-hole construction formed in the cover are used as a channel and a cover reservoir that holds liquid, respectively. The unification of the cover and the cover reservoir simplifies construction and facilitates the microchip fabrication process. The chip proposed in Non-Patent Document 1 is used in DNA amplification and size separation of amplified DNA.

Multidimensional analysis in which one analysis sample is subjected to a plurality of analyses is ideal for carrying out separation or identification of bio-substances or chemical substances with greater accuracy. For example, a device is proposed in Non-Patent Document 2 in which an analysis sample is introduced into a channel on a microchip and, following separation in the channel by means of capillary-electrophoresis, MALDI-MS (Matrix-assisted laser desorption/ionization mass spectrometry) is used to obtain molecular weight information as well as a spot position regarding the substance that is the object of analysis that has been separated along this channel (Ken Tseng, et al., Part of the SPIE Conference on Micro- and Nanofabricated Structures and Devices for Biomedical Environmental Applications 2, SPIE Vol. 3606, 137-148 (1999)).

In MALDI-MS, crystals composed of a matrix and the substance that is the object of analysis are subjected to direct laser irradiation to effect desorption/ionization of the substance that is the object of analysis, and the channel following separation by means of electrophoresis must therefore be exposed. Still further, an analysis sample is in a liquid state in electrophoresis separation, which is the first-dimension analysis, but must be in a dry state in MALDI-MS, which is the second-dimension analysis, and the separated state of the liquid analysis sample must therefore be maintained without change in the dry state.

In Non-Patent Document 2, a trench-shaped channel is formed in the substrate of the microchip, and this channel is used as is in an open state without being covered. The analysis sample that contains a matrix and the substance that is the object of analysis in the channel is first subjected to electrophoresis separation and the solvent in the channel is then left to dry and the substance that is the object of analysis after separation is caused to crystallize with the matrix and solidify in the channel. Finally, the channel is scanned by a laser to detect the substance that is the object of analysis.

As in Non-Patent Document 2, using a channel that is left open gives rise to the problems that during separation by electrophoresis, substances outside the chip may enter the channel and thus contaminate the analysis sample or the analysis sample inside the channel may spill out of the channel. To solve these problems, a microchip in which a removable cover is used to seal the channel is proposed in Patent Document 1 (WO2005/026742).

The microchip disclosed in Patent Document 1 is provided with a substrate in which a channel and a substrate reservoir have been formed and a detachable cover in which an opening composed of a through-hole is formed at a position that corresponds to the substrate reservoir and that closely but detachably adheres to the substrate.

The capacity of the substrate reservoir is minute, but the close contact of the substrate and cover and communication between the opening and substrate reservoir allow the holding of reservoir liquid necessary for carrying out electrophoresis separation. If this microchip is used, the substance that is the object of analysis can be separated in the sealed channel in a state that prevents contamination or spillage, and after the analysis sample has been frozen and fixed, the cover can be removed to allow exposure of the channel. The analysis sample that has been frozen, fixed, and exposed is dried while in a frozen state (i.e., freeze-dried) to maintain the separated state.

Freeze-drying for drying at reduced pressure not only entails complex equipment due to the need for components such as a vacuum pump but also requires a long time for drying. In addition, the sample following drying is a fine powder and the danger therefore exists for dispersion outside the channel resulting in contamination of the surroundings. Freeze drying is suitable when the substance that is the object of analysis undergoes a decomposition reaction when heat is applied for drying.

Drying by heating is another method for drying an analysis sample that has been frozen and fixed. Heat-drying entails only the heating of the substrate and the solvent of the analysis sample in the channel can therefore be quickly dried by means of a simple device. Thus, depending on the sample and components that are the objects of analysis, drying is often more suitable than freeze-drying.

### Non-Patent Document 1: Hong, J. W. et al., Electrophoresis, Vol. 22, 328-333 (2001)

### Non-Patent Document 2: Ken Tseng, et al., Part of the SPIE Conference on Micro- and Nanofabricated Structures and Devices for Biomedical Environmental Applications 2, SPIE, Vol. 3606, 137-148 (1999)

### Patent Document 1: WO2005/026742

### DISCLOSURE OF THE INVENTION

### Problem to be Solved by the Invention

The drawback of the microchip disclosed in Patent Document 1 is that when the cover is removed after freezing and fixing the analysis sample, the reservoir liquid of the opening is frozen and remains on the substrate. Although the ultimate requirement is the ability to dry and obtain only the interior of the channel that contains the analysis sample, the capacity of the opening is extremely large compared to the capacity of the channel formed on the substrate or the substrate reservoir, and a long time is therefore required for drying.

In addition, the adoption of heat-drying raises the additional problem that when a large amount of reservoir liquid remains on the substrate in a frozen state, the reservoir liquid in some cases spreads over the substrate during heat-drying, mixes with the sample in the channel, and prevents the absolute maintenance of the separated state of the substance that is the object of analysis.

Even when the reservoir liquid does not spread across the substrate, the reservoir liquid that is melted by heating in some cases flows into the channel and moves the substance that is the object of analysis that was separated in the channel. It was therefore found that, despite the implementation of separation with high separation capabilities, the separated state was disrupted when drying the solvent of the analysis sample.

The present invention was realized in view of the problems inherent to the above-described related art, and it is therefore an object of the present invention to provide a microchip that, after using the analysis microchip to implement a separation operation such as electrophoresis, allows the removal of a cover that is secured to the upper surface of a substrate that forms the analysis microchip without contaminating or spilling the analysis sample that contains a substance that is the object of analysis, and further, that allows drying and fixing of the substance that is the object of analysis in a state in which the degree of separation of the separation operation is maintained, and further, to provide an analysis method that uses this microchip.

### Means for Solving the Problem

The microchip of the present invention is a microchip composed of a substrate and a cover; wherein:

the substrate is provided with a trench-shaped channel on its upper surface and substrate reservoirs linked to the channel;

the cover tightly seals the upper surface of the channel and can be attached to and detached from the substrate and is provided with: through-holes formed at positions corresponding to the substrate reservoirs, cover reservoirs formed on the inner sides of the through-holes for holding liquid that is introduced when the cover seals the upper surface of the channel, and partitions formed on the bottom planes of said cover reservoir; and

the area of the open portions of the partitions is smaller than the area of the open portions of the cover reservoirs over the partitions.

According to the microchip of the above-described present invention, the frozen reservoir liquid is broken along the bottom plane of the cover reservoirs when the cover is removed when the analysis sample/reservoir liquid are in a frozen state, and as a result, the frozen reservoir liquid in the cover reservoirs can be removed while held in the cover reservoirs.

This effect is obtained because the portion of the frozen reservoir liquid that makes contact through the partition portions has a small cross section and is therefore a physically weak part that is easily broken. In addition, the partitions serve as obstructions when frozen reservoir liquid that is above the bottom plane drops down and can thus hold the frozen reservoir liquid in the cover reservoirs.

The frozen reservoir liquid in the cover reservoirs therefore does not remain on the side of the substrate, and the analysis sample can therefore be dried in a short time. In addition, this configuration prevents the melting of frozen reservoir liquid and consequent flow into the channel when the substrate is heated. This configuration therefore suppresses the phenomenon by which the substance that is the object of analysis is moved in the channel together with the analysis sample until all of the solvent evaporates and can therefore maintain the separated state of the substance that is the object of analysis in the channel.

In this case, the through-holes may also serve as the cover reservoirs.

According to the microchip of the present invention described hereinabove, the through-holes of the cover also serve as the cover reservoirs and the configuration of the cover can therefore be simplified. As a result, a cover that includes cover reservoirs can be fabricated with high throughput.

In addition, the cover reservoirs and the partitions may be of the same material.

According to the microchip of the present invention as described hereinabove, the cover reservoirs and partitions can be fabricated simultaneously using a single forming die, or the partitions can be easily fabricated in the cover reservoirs by a process in which the bottom planes of the cover reservoirs are pressed toward the inside diameter. The consequent easy fabrication of the cover reservoirs and partitions enables fabrication at high throughput.

In addition, the partitions may be convex constructions that protrude toward the inside diameters of the cover reservoirs.

According to the microchip of the present invention as described hereinabove, when the cover is removed with the analysis sample and reservoir liquid in a frozen state, the frozen reservoir liquid can be broken off along the bottom planes of the cover reservoirs, and further, the frozen reservoir liquid in the cover reservoirs can be removed while adhered to the cover.

This effect can be obtained because the portions of the frozen reservoir liquid that makes contact through the above-described convex constructions that protrude toward the inner diameters of the cover reservoirs have a small cross section and are therefore mechanically weak parts and easily broken. In addition, the convex constructions that protrude toward the inner diameters of the cover reservoirs serve as obstacles to the fall of overlying frozen reservoir liquid, and the frozen reservoir liquid in the cover reservoirs is therefore removed together with the cover.

In addition, the convex constructions that protrude toward the insides of the cover reservoirs are simple and easily formed constructions, and the throughput of the fabrication of cover reservoirs having partitions can therefore be increased.

The partitions may be films having minute through-holes or voids through which ions can pass.

According to the microchip of the present invention as described hereinabove, when removing the cover with the analysis sample and reservoir liquid in a frozen state, the frozen reservoir liquid is broken off along the bottom planes of the cover reservoirs, and further, the frozen reservoir liquid in the cover reservoirs can be removed while adhered to the cover. This effect can be obtained because the films that have minute through-holes or voids through which ions can pass reduce the area of the openings of the bottom planes of the cover reservoirs, and by extension, reduce the cross section of the frozen reservoir liquid, whereby the bottom planes of the cover reservoirs are rendered mechanically weak portions and easily break. In addition, films having minute through-holes or voids through which ions can pass support points close to the centers of gravity of overlying frozen reservoir liquid and can therefore easily hold the frozen reservoir liquid and can be removed from the substrate together with the cover. As a result, frozen reservoir liquid in the cover reservoirs does not remain on the substrate side.

In addition, protruding constructions that reduce the area of the surfaces of the partitions that contact the substrate may be formed in the substrate reservoirs.

According to the microchip of the present invention as described hereinabove, the frozen reservoir liquid can be broken along the bottom planes of the cover reservoirs when removing the cover with the analysis sample and reservoir liquid in a frozen state.

This effect can be obtained because the cross sections of the frozen reservoir liquid at the bottom planes of the cover reservoirs are reduced not only by the partitions but also by the protruding constructions. In addition, protruding constructions having hydrophilic surfaces may be formed in the channel.

In the microchip of the above-described present invention, protruding constructions having hydrophilic surfaces increase the hydrophilic properties and surface area of the channel and thus increase the capillary force and friction that acts on a solution in the channel and can impede movement of an analysis sample in the channel. This effect can be obtained both because friction can act between the channel surface and the surfaces of the protruding constructions to impede movement when the analysis sample moves and because the melted analysis sample around the perimeters of the protruding constructions can be held by the capillary force of the protruding constructions. The hydrophilic property of the above-described example is for a case in which the contact angle is no greater than 90°.

The microchip of the present invention is particularly desirable when a portion of the frozen reservoir liquid in a cover reservoir remains on a substrate reservoir without being removed and the substrate is not heated uniformly. Melted reservoir liquid that remains on a substrate reservoir enters an energetically unstable state and overflows onto the upper surface of the substrate reservoir. In particular, when the substrate is not heated uniformly and drying of the analysis sample begins from each part in the channel, this melted reservoir liquid moves in the channel and substrate reservoirs that are covered by walls and that are more stable in terms of energy and thus pushes against and moves the solution in the channel in the direction of the part of the channel that has dried. This movement seriously disrupts the separated state of the substance that is the object of analysis in the analysis sample of the channel.

However, the provision of protruding constructions enables retention of the melted analysis sample around the peripheries of the protruding constructions, and movement of the analysis sample away from the protruding constructions is therefore impeded. In addition, fabricating the protruding constructions from a material having lower specific heat than the analysis sample in the channel enables rapid transfer of the temperature of the analysis sample that spreads from the bottom surface of the substrate. As a result, the analysis sample can be dried in a short time.

In this case, the protruding constructions in the channel may be arranged as rows in the direction of width of the channel, and adjacent rows of the protruding constructions may be arranged at positions shifted in the width direction of the channel.

According to the microchip of the present invention as described above, when a flow occurs in the analysis sample that has melted in the channel, this flow collides with the next row of the protruding constructions and thus loses speed, whereby the flow can be impeded. The movement of the analysis sample in the channel is thus impeded. Even when the substrate is heated unevenly and reservoir liquid that could not be removed melts and presses against the analysis sample in the channel, the capability to maintain the separated state of the substance that is the object of analysis in the analysis sample is augmented.

In addition, the protruding constructions in the channel may be formed such that fluid that moves through the channel moves in a zigzag form.

The channel shape of the microchip of the present invention as described above causes the flow of the analysis sample that occurs in the channel to collide with not only the protruding constructions but also with the wall surfaces of the channel and can thus retard the flow. Even in a case in which the substrate is unevenly heated and the portion of reservoir liquid take remains on a substrate reservoir can not be removed melts and presses against the analysis sample in the channel, the capability to maintain the separated state of the substance that is the object of analysis in the analysis sample is augmented. In addition, the capability to maintain this separated state is exhibited even when the solvent of the analysis sample is locally vaporized due to uneven heating.

The microchip according to another embodiment of the present invention is a microchip composed of a substrate and a cover, wherein:

the substrate is provided with a trench-shaped channel on its upper surface and substrate reservoirs linked with the channel;

the cover seals the upper surface of said channel, can be attached to and detached from the substrate, and is provided with cover reservoirs formed at positions corresponding to the substrate reservoirs and that hold liquid introduced when the cover is in a state of sealing the upper surface of the channel;

the microchip is used for implementing: a separation step of using the microchip to separate an analysis sample, a cooling step of cooling the substrate to freeze the analysis sample and reservoir liquid, and a cover-detaching step of detaching the cover; and

constructions are included on the bottom planes of the cover reservoirs for breaking frozen reservoir liquid at the bottom planes of the cover reservoirs and for detaching the frozen reservoir liquid from the substrate together with the cover in the cover-detaching step.

According to the microchip of the present invention as described above, after the step of using the microchip to separate an analysis sample and the step of cooling the substrate to freeze the analysis sample and reservoir liquid, the frozen reservoir liquid can be broken at the bottom planes of the cover reservoirs and withdrawn from the substrate together with the cover in the cover-detaching step.

A microchip according to yet another embodiment of the present invention is a microchip composed of a substrate and a cover, wherein: the substrate is provided with a trench-shaped channel on its upper surface and substrate reservoirs linked with the channel;

the cover seals the upper surface of the channel, can be attached to or detached from the substrate, and is provided with through-holes formed at positions corresponding to the substrate reservoirs and cover reservoirs formed on the inner sides of the through-holes for holding liquid introduced when the cover is in a state of sealing the upper surface of the channel; and

protruding constructions are formed in the substrate reservoirs for reducing the area of the surfaces of the partitions that make contact with the substrate.

The utilization method that uses the microchip of the present invention is a sample analysis method that uses any of the above-described microchips and is characterized by the implementation of the series of steps of:

a cooling step of, after using the channel to separate an analysis sample that includes a substance that is the object of analysis by means of a desired process such as electrophoresis, cooling the substrate to attain a prescribed low temperature condition that is the freezing point of the analysis sample or lower to implement an operation for freezing the analysis sample and reservoir liquid that are held in the channel and for which separation has been completed by a process such as electrophoresis;

a cover detachment step of implementing an operation to detach/remove the cover from the substrate by: while maintaining a state in which the substrate is kept cooled to the prescribed low temperature to keep the analysis sample that has undergone separation by a process such as electrophoresis in a frozen state, placing the upper surface of the substrate and the lower surface of the cover in close contact in order to withdraw reservoir liquid from inside the channel while still adhered to the cover, which is adhered in the channel and, which is further frozen inside the cover reservoir, and applying an external force to the end of the cover to detach the lower surface of the cover from the upper surface of the substrate in order to implement an operation for releasing bonding force that achieves a bonded state in a prescribed arrangement; and

a heating step of, after completing the detaching step, implementing an operation upon an analysis sample that has undergone a separation process such as electrophoresis and that is held inside the channel and moreover that is exposed, wherein the substrate is heated to dry solvent that is contained.

By using the above-described microchip to carry out the above-described sample analysis method, the cover can be simply and easily removed from the substrate after separation and freezing of the analysis sample, and further, heating the substrate can convert the analysis sample from a liquid state to a dry state in a short time while maintaining the separated state of the exposed substance that is the object of analysis. After drying, the substance that is the object of analysis that has undergone separation can be analyzed by a further desired analysis operation.

In this case, the cover-detaching step may be a step of implementing an operation for detaching/removing the cover from the substrate in a dry gas atmosphere.

By using the above-described microchip to carry out the above-described sample analysis method, the cover-detaching step becomes more complex, but the drying step can be carried out with good reproducibility. This effect can be obtained because decreasing the amount of moisture in the gas atmosphere surrounding the substrate when removing the cover from the cooled substrate reduces the amount of frost that adheres to the substrate and can thus prevent the destruction of the separated state of the substance that is the object of analysis when frost on the substrate surface melts during heating of the substrate and flows into the channel. In addition, the time required for drying the adhered frost is shortened. As a result, after separation and freezing of the analysis sample, the cover can be removed from the substrate while preventing the adherence of frost, and further, heating of the substrate can be implemented while maintaining the separated state of the exposed substance that is the object of analysis, and the analysis sample can be converted from a liquid state to a dry state in a short time.

By using the microchip according to the present invention and the sample analysis method that employs the microchip, a technique is realized for, after subjecting the analysis sample to a separation operation such as electrophoresis without contamination or spillage on the microchip, removing the cover that is secured to the upper surface of the substrate that makes up the microchip and drying and fixing the analysis sample in a short time in a state that maintains the separation capability of the separation operation.

### BRIEF DESCRIPTION OF THE DRAWINGS

FIGS. 1(a) to 1(d) are cross-sectional views showing in stages the operations for analysis that use a microchip of the related art;

FIG. 2(a) is a top view showing the constituent parts of a microchip of the present embodiment, and FIG. 2(b) is a top view showing the constituent parts of a microchip of the present embodiment at the B-B′ section of FIG. 3;

FIG. 3 is a cross-sectional view showing the section across A-A′ of the microchip of the present embodiment shown in FIG. 2(a);

FIG. 4 is a cross-sectional view showing an enlargement of a cross section in the vicinity of a cover reservoir of the microchip used in the first embodiment of the present invention;

FIGS. 5(a) to 5(d) are cross-sectional views showing in stages the analysis operations that use the microchip used in the first embodiment of the present invention;

FIG. 6 is a cross-sectional view showing an enlargement of the cross section of the vicinity of the cover reservoir of the microchip used in the second embodiment of the present invention;

FIG. 7 is a cross-sectional view showing an enlargement of the cross section of the vicinity of the cover reservoir of the microchip used in the third embodiment of the present invention;

FIG. 8(a) is a top view showing the constituent parts of the microchip used in the third embodiment of the present invention, and FIG. 8(b) is a top view showing the constituent parts of the microchip of the present embodiment at the B-B′ section in FIG. 7;

FIGS. 9(a) and 9(b) are a top view and a perspective view, respectively, showing an enlargement of the channel of the microchip used in the fourth embodiment of the present embodiment; and

FIG. 10 is a cross-sectional view of the cover used in the second working example of the present invention.

### EXPLANATION OF REFERENCE NUMBERS

101 substrate
102 cover
103 cover reservoir
104 partition
105 channel
106 substrate reservoir
107 microchip
108 analysis sample/reservoir liquid
110 protruding construction

### BEST MODE FOR CARRYING OUT THE INVENTION

Explanation next regards embodiments of the present invention with reference to the accompanying figures. In all of the figures, common constituent elements are given the same reference numbers and redundant explanation is omitted.

### First Embodiment

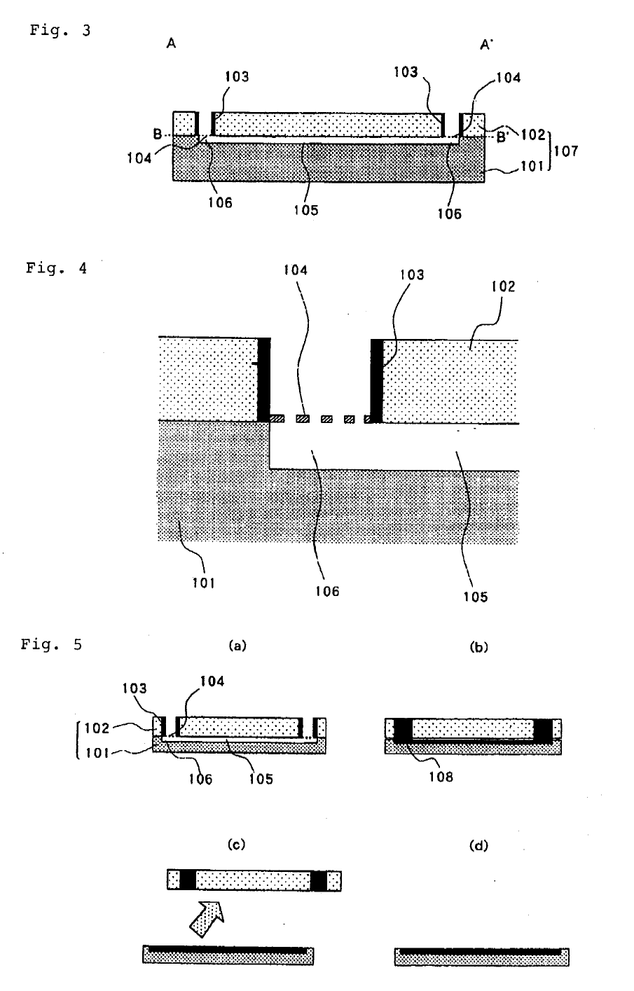

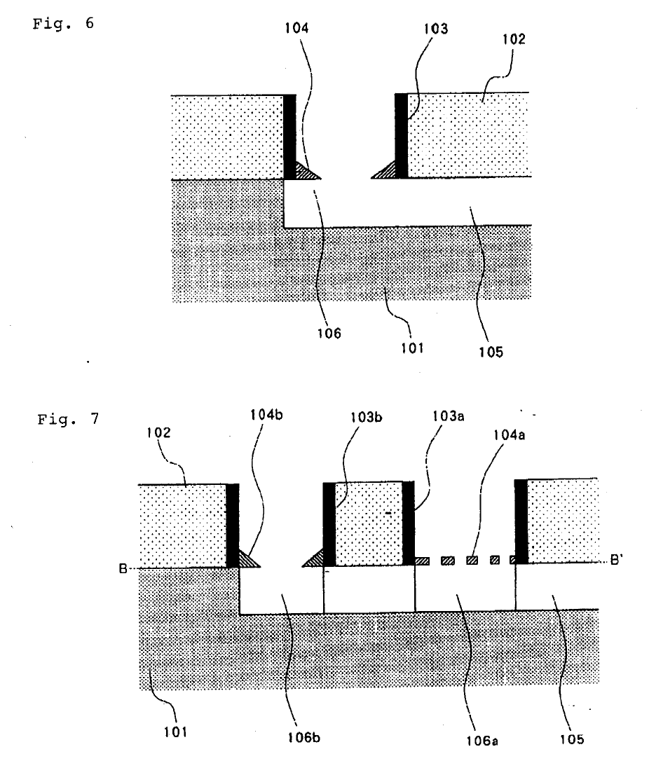

FIG. 2(a) is a top view showing the constituent parts of the microchip of the present embodiment, and FIG. 2(b) is a top view showing the constituent parts of the microchip of the present embodiment at section B-B′ of FIG. 3. FIG. 3 is a cross-sectional view showing the section at A-A′ of the microchip of the present embodiment shown in FIG. 2(a). FIG. 4 is a cross-sectional view showing an enlargement of a section in the vicinity of a cover reservoir of the microchip of the present embodiment. FIG. 5 is a cross-sectional view showing in stages the analysis operations that use the microchip of the present embodiment.

In the channel configuration of the present embodiment, substrate 101 is provided on its upper surface with channel 105 that is used in the separation of the substance that is the object of analysis. Substrate reservoirs 106 are formed at both ends of channel 105.

Cover 102 that seals channel 105 of substrate 101 is provided with through-holes at positions corresponding to the position of each substrate reservoir 106, the inner sides of these through-holes being provided with cover reservoirs 103 for holding liquid. Each cover reservoir 103 includes partition 104 on the bottom plane that is on the substrate 101 side (as shown in FIG. 5(a)). As shown in FIG. 4, partitions 104 are films having minute through-holes or voids through which ions can pass and are bonded to cover reservoir 103.

In the present embodiment, an example is explained in which the microchip is used to realize isoelectric point separation of an analysis sample, but the analysis method of the analysis sample is not limited to this method.

After an analysis sample that contains a carrier ampholyte for establishing a pH gradient is introduced into channel 105 through cover reservoirs 103, an acidic liquid (anolyte) for establishing the pH gradient, which is the reservoir liquid, is introduced to one cover reservoir 103, and a base liquid (catholyte) is introduced to the other cover reservoir 103. Electrode ends for applying an electrical field are next inserted into cover reservoirs 103 and an electrical field used in moving protein in channel 105 is applied between these electrodes.

The shape of channel 105 shown by way of example in FIG. 2(b) is of a one-lane configuration, but the present invention can also be extended to a microchip of a multi-lane configuration in which a plurality of trench-shaped channels are juxtaposed on the upper surface of substrate 101.

When the substance that is the object of analysis has been separated in channel 105 for each isoelectric point, the application of the electrical field is halted and substrate 101 is cooled to freeze the analysis sample and reservoir liquid (This is the state of FIG. 5(b). The analysis sample and reservoir liquid 108 are frozen).

Cover 102 is detached from substrate 101 with the analysis sample and reservoir liquid kept frozen. After removal, the frozen analysis sample is kept in channel 105 with the separated state maintained unchanged. When cover 102 is detached, partitions 104 constrict the cross sections of the frozen liquid of the bottom planes of cover reservoirs 103 and thus mechanically weaken the frozen reservoir liquid, whereby the frozen reservoir liquid breaks along partitions 104. The frozen reservoir liquid in cover reservoirs 103 is removed while held inside cover reservoirs 103 (as shown in FIG. 5(c)).

Substrate 101 is next heated, and the solvent of the analysis sample is vaporized, Because the frozen reservoir liquid in cover reservoirs 103 no longer remains on the substrate 101 side, the melting of the frozen reservoir liquid and its subsequent flow into channel 105 is eliminated (the state of FIG. 5(d)). As a result, the separated state of the substance that is the object of analysis can be maintained without change, and the solvent of the analysis sample can be vaporized in a short time.

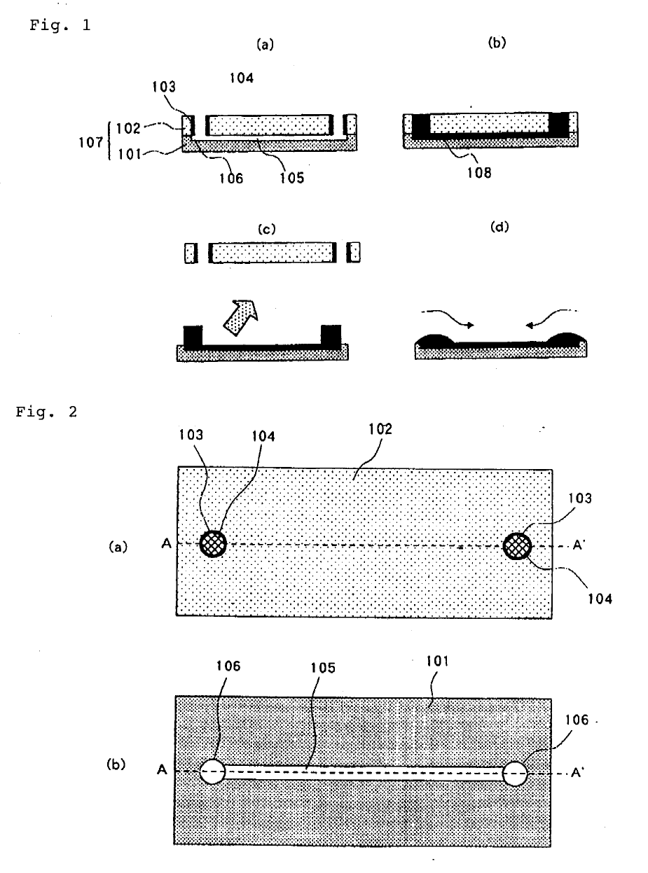

On the other hand, FIG. 1 shows cross-sectional views showing in stages the analysis operations that use microchip 107 that lacks partitions 104.

The operations including the introduction of the analysis sample, the introduction of the acidic liquid (anolyte) for establishing a pH gradient, this anolyte being the reservoir liquid, to one of cover reservoirs 103, and the introduction of a base liquid (catholyte) to the other cover reservoir 103, and the freezing following the application of an electrical field by means of electrode ends for electrical field application shown in FIGS. 1(a) and 1(b) are the same as the operations described using FIGS. 5(a) and 5(b).

When microchip 107 that lacks partitions 104 is used, the frozen reservoir liquid inside cover reservoirs 103 remains in substrate reservoirs 106 when cover 102 is removed after freezing the analysis sample (the state of FIG. 1(c)). When substrate 101 is heated, the frozen reservoir liquid that remains in substrate reservoirs 106 melts and flows into channel 105 (the state of FIG. 1(d)), and destroys the separated state of the substance that is the object of analysis. In addition, the drying of the reservoir liquid takes more time.

As material of substrate 101 of the present embodiment, a material suitable for micro-processing such as quartz, glass, or silicon is ideally used. Still further, a plastic material having high insulation properties such as polycarbonate, PDMS, and PMMA that can achieve the target micro-processing accuracy can also be used.

Because an electrical field is applied to the trench-shaped channel that is formed on the upper surface of substrate 101, substrate 101 itself must be insulated from the migration liquid in the trench-shaped channels, and the use of a highly insulative material such as quartz or glass is therefore preferable. When using a material having inferior insulation such as silicon, a configuration is adopted in which an insulating cover layer is provided on the inner walls of the trench-shaped channel to achieve electrical insulation from the migration liquid in the trench-shaped channel. Alternatively, a form can be adopted in which the trench-shaped channel portion is formed using a silicon oxide layer formed on a silicon substrate.

A material having superior insulation properties and that allows the implementation of processes such as for the fabrication of through-holes is suitable for use as the material of cover 102 of the present embodiment. Materials that can be used include: acrylic resins such as polycarbonate and PMMA (polymethylmethacrylate), polymer resin materials such as PDMS (polydimethylsiloxane), polyolefins such as PTFE (polytetrafluoroethylene), PP (polypropylene), PE (polyethylene), and polyvinyl dichloride, or polyesters. Materials having high elastic deformation properties are particularly preferable. Cover 102 is fabricated using methods such as die-forming, extrusion molding, and hot embossing.

A material having superior insulation properties and that allows the implementation of processing such as the formation of through-holes is suitable as the material of cover reservoirs 103 of the present embodiment. Such materials include quartz or glass, or a plastic material having high insulation properties: acrylic resins having high insulation properties such as polycarbonate and PMMA (polymethylmethacrylate), polymer resin materials such as PDMS (polydimethylsiloxane), polyolefins such as PTFE (polytetrafluoroethylene), PP (polypropylene), PE (polyethylene), and polyvinyl dichloride, or polyesters. When a plastic material is used for cover 102, cover 102 is produced using a method such as die-forming, extrusion molding, and hot embossing. The through-holes included in cover 102 may also serve as cover reservoirs 103. In this case, cover 102 and cover reservoirs 103 can be formed by monobloc forming of the same material and the configuration of the cover can be simplified.

Materials suitable for the material of partitions 104 of the present embodiment include mesh produced from a plastic material, which is a film material having minute through-holes or voids through which ions can pass, a fabric having a mesh size large enough to allow the inflow of a solution, and paper. These partitions 104 are preferably formed by combining with cover reservoirs 103. Monobloc formation is possible when the same material is used for cover reservoirs 103 and for these partitions 104. Alternatively, partitions 104 may be bonded to cover reservoirs 103 by an adhesive. Alternatively, partitions 104 may be installed or bonded to the bottom surfaces of cover reservoirs 103 after bonding and securing substrate 101 and cover 102.

### Second Embodiment

FIG. 6 is a cross-sectional view showing an enlarged cross section in the vicinity of cover reservoir 103 of the microchip according to the present embodiment, The microchip according to the present embodiment is of the same microchip configuration as the first embodiment, differing only regarding the configuration of partitions 104. Partitions 104 of the present embodiment are of a convex construction that protrude toward the inside diameter of cover reservoir 103.

As in the first embodiment, after the substance that is the object of analysis has been separated in channel 105, substrate 101 is cooled to freeze the analysis sample and reservoir liquid. Cover 102 is removed from substrate 101 with the analysis sample remaining frozen. At this time, partitions 104 cause the frozen reservoir liquid to break along partitions 104, and the frozen reservoir liquid can thus be split between the side of cover reservoirs 103 of cover 102 and the side of substrate reservoirs 106. The frozen reservoir liquid in cover reservoirs 103 is removed while adhered to cover 102, and in this way, the melting of the frozen reservoir liquid during heating of substrate 101 and the consequent flow into channel 105 can be prevented. As a result, the separated state of the substance that is the object of analysis can be maintained without change and the solvent of the analysis sample can be vaporized in a short time.

The same materials as in the first embodiment are suitable as the materials of substrate 101, cover 102, cover reservoirs 103, and partitions 104. Using the same materials for cover 102 and cover reservoirs 103, or for cover reservoirs 103 and partitions 104, or for all of these parts enables monobloc formation and is therefore preferable.

Partitions 104 of the present embodiment are not limited to a convex construction and may be of a conical construction in which the tube diameter of the cover reservoirs decreases as it gets closer to the substrate. The bottom surface of this conical configuration is preferably equivalent to the upper surface of substrate 101, and the thickness of the conical configuration preferably decreases with approach to the center of cover reservoir 103. This configuration is preferable because cracks tend to occur in the frozen reservoir liquid along the upper surface of substrate 101 and the amount of reservoir liquid that remains on the substrate 101 side can therefore be decreased.

### Third Embodiment

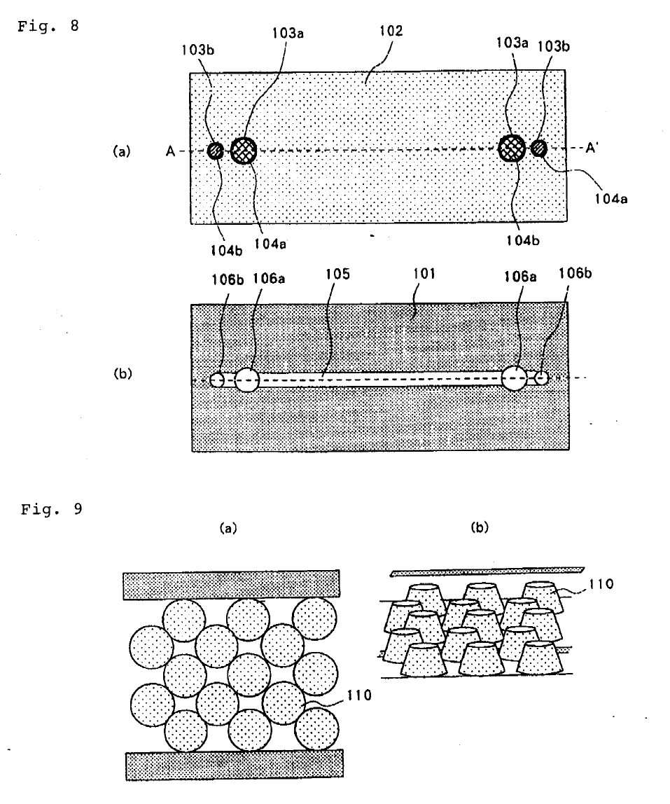

FIG. 7 is a cross-sectional view of the microchip according to the present embodiment. FIG. 8 is a top view showing the constituent parts of the microchip of the present embodiment. FIG. 7 shows an enlargement of a cross section in the vicinity of a cover reservoir between A-A′ in FIG. 8(a), FIG. 8(a) shows the state in which substrate 101 and cover 102 are combined, and FIG. 8(b) shows the cutting plane that joins B-B′ in FIG. 7 (top view of cover 102).

The microchip according to the present embodiment is of the same microchip configuration as the first embodiment and second embodiment but includes cover reservoirs 103 and substrate reservoirs 106 at the two ends of channel 105 as well as at positions inward from the two ends, resulting in a total of four of each: two cover reservoirs 103 and substrate reservoirs 106 at the two ends and two cover reservoirs 103 and substrate reservoirs 106 at positions inward from the two ends.

Cover reservoirs 103b provided at the two ends of channel 105 are provided with partitions 104b of a configuration equivalent to that of the second embodiment shown in FIG. 6 and are arranged corresponding to the positions of substrate reservoirs 106b for injecting liquid to channel 105.

Cover reservoirs 103a provided toward the inside from the two ends of channel 105 are provided with partitions 104a of a configuration equivalent to that of the first embodiment shown in FIG. 4 and electrodes for applying voltage to channel 105 are inserted to carry out analysis. Cover reservoirs 103a are arranged corresponding to the positions of substrate reservoirs 106a.

Partitions 104a are films of a different material than cover 102 and have minute voids through which ions can enter and exit between cover reservoirs 103a and substrate reservoirs 106a. Partitions 104b are of the same material as cover 102 and are convex constructions that protrude toward the inner diameter of the cover reservoirs. When liquid cannot be injected into channel 105 through partitions 104a, the liquid can be injected through cover reservoirs 103b that have partitions 104b.

In the present embodiment, a case is described in which a microchip is used to realize isoelectric point separation of an analysis sample. After an analysis sample containing a carrier ampholyte for establishing a pH gradient has been introduced through cover reservoirs 103b to channel 105, an acidic liquid (anolyte) for establishing a pH gradient, and which is a reservoir liquid, is introduced to one of cover reservoirs 103a and a base liquid (catholyte) is introduced into the other cover reservoir 103a.

Electrode ends for applying an electrical field are next inserted into cover reservoirs 103a, and an electrical field is applied that is used when moving protein in channel 105 between these electrode ends. The application of the electrical field is halted when the substance that is the object of analysis has been separated in channel 105 for each isoelectric point, and substrate 101 is cooled to freeze the analysis sample and reservoir liquid.

Cover 102 is removed from substrate 101 with the analysis sample and reservoir liquid kept frozen. At this time, partitions 104a and 104b at the bottom planes of cover reservoirs 103a and 103b cause cracks in the frozen reservoir liquid along partitions 104a and 104b, whereby the frozen reservoir liquid in cover reservoirs 103a and 103b can be removed. As a result, melting of frozen reservoir liquid and consequent flow into channel 105 can be eliminated, and the substance that is the object of analysis is heated and dried while maintaining the separated state.

The same materials as in the first embodiment are suitable as the materials of substrate 101, cover 102, and cover reservoirs 103a and 103b of the present embodiment. As material of partitions 104a, a film is used that has minute through-holes or voids through which ions can pass.

For example, partitions 104a are preferably a film that passes only ions in a solution or molecules no larger than a desired size, such as a semipermeable membrane, a dialysis membrane, a filter, filter paper, cellulose, polyvinylidene fluoride (PVDF) film, or a gel such as an acrylamide gel or agarose gel. These partitions 104 are preferably formed by combining with cover reservoirs 103.

Monobloc formation is possible when the materials of cover reservoirs 103 and partitions 104 are the same. Alternatively, partitions 104 may be bonded by an adhesive to cover reservoirs 103.

For example, when a gel such as agarose or acrylamide is used for partitions 104a, partitions 104a are preferably produced by, after bonding substrate 101 and cover 102, dripping gel that has been warmed and that is in a liquid state into cover reservoirs 103a and then curing.

On the other hand, the same material as the material for partitions

104 of the first embodiment is suitable as the material of partitions 104b. Using the same material for cover 102 and cover reservoirs 103b, or for cover reservoir 103b and partitions 104b, or for all of these parts enables monobloc formation and is therefore preferable.

### Fourth Embodiment

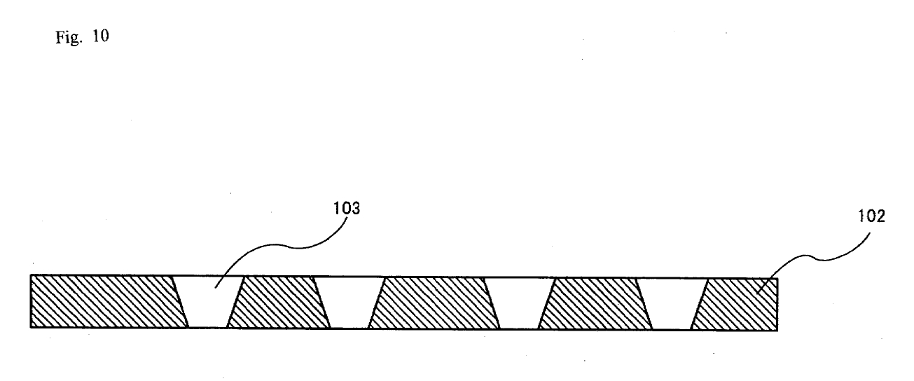

FIGS. 9(a) and 9(b) are a top view and perspective view, respectively, showing an enlargement of the channel of the microchip according to the present embodiment.

The configuration of the cover of the microchip according to the present embodiment is of the same microchip configuration as the first to third embodiments, but channel 105 in the present embodiment is formed to realize movement in a zigzag shape (hereinbelow referred to as “zigzag shape”). As shown in FIG. 9, protruding constructions 110 are arranged as rows in the width direction of the channel in channel 105, the adjacent rows of protruding constructions 110 being arranged at positions shifted in the width direction of the channel.

The configuration of the cover of the microchip according to the present embodiment is of the same microchip configuration as the first to third embodiments, but protruding constructions 110 having a hydrophilic surface are formed in channel 105 in the present embodiment such that fluid moves in a zigzag shape (hereinbelow referred to as a “zigzag shape”). As shown in FIG. 9, protruding constructions 110 in channel 105 are arranged as rows in the width direction of the channel, and adjacent rows of protruding constructions 110 are arranged at positions shifted in the width direction of the channel.

As in the first to third embodiments, cover 102 is removed from substrate 101 with the analysis sample that has been separated in channel 105 in a frozen state. At this time, partitions 104 cause the frozen reservoir liquid to break along the bottom planes of cover reservoirs 103, whereby the frozen reservoir liquid in cover reservoirs 103 can be removed. As a result, frozen reservoir liquid does not melt and flow into channel 105, and the substance that is the object of analysis is heated and dried while maintained in its separated state.

During heating of substrate 101, the analysis sample is held in the vicinity of each protruding construction 110 by the capillary force of each protruding construction 110 in channel 105, whereby the flow of the analysis sample away from each protruding construction is impeded. As a result, destruction of the separated state can be suppressed even when the portion of the frozen reservoir liquid that remains on the substrate 101 side melts and flows into the channel, or even when uneven heating causes localized evaporation of the solvent of the analysis sample.

In addition, the next row of protruding constructions 110 that is arranged with a shift stops the flow of the analysis sample that starts between the preceding row of protruding constructions 110, thereby making the movement of the analysis sample more difficult. Still further, the flow of the analysis sample also collides with the channel walls of channel 105 that is in a zigzag shape, thereby making the flow of the analysis sample still more difficult.

A configuration may be adopted in which protruding constructions that decrease the area of the surfaces of the partitions that make contact with the substrate are also provided in the substrate reservoirs, and a configuration in which this type of protruding construction is provided may be adopted in any of the above-described embodiments. Adopting this type of configuration causes reduction of the cross section of the frozen reservoir liquid at the bottom plane of the cover reservoirs, whereby the frozen reservoir liquid can be broken along the bottom plane of the cover reservoirs when the cover is removed while the analysis sample and reservoir liquid are in a frozen state.

### WORKING EXAMPLE 1

The inventors of the present invention used the chip described hereinbelow to carry out a drying and fixing experiment on an analysis sample following isoelectric point separation and showed that the analysis sample can be dried and fixed in a short time while maintaining the separated state without change.

The substrate of the microchip was a synthetic quartz substrate in a square shape 21 mm, a channel being formed by photolithography and dry etching on the upper surface. The channel was 400 microns wide and 60 mm long and was formed in a zigzag shape. Column-shaped constructions with a diameter of 10 microns and a pitch of 20 microns were formed uniformly inside the channel, with substrate reservoirs at both ends of the channel.

The cover was of silicone resin (PDMS) 2 mm thick, and through-holes with a diameter of 2 mm were formed at positions corresponding to the substrate reservoirs, these through-holes also serving as cover reservoirs. The cover reservoirs included convex constructions made of PDMS protruding in the direction of the inner diameter of each cover reservoir as constructions for reducing the area of the openings of the bottom planes of the cover reservoirs. The cover, the cover reservoirs, and the constructions for reducing the area of the openings of the bottom planes of the cover reservoirs were all made of the same silicone resin, and were formed by monobloc forming. For this formation, a silicone resin material and a curing agent were mixed, caused to flow into a forming die, and heated for one hour at 150° to cure.

A rectangular synthetic quartz plate having a thickness of 0.5 mm in which through-holes were formed at positions corresponding to the cover reservoirs was mounted on the cover. The microchip was mounted on a Peltier stage having cooling and heating capabilities and analyzed. A fastening device was used to apply pressure from the synthetic quartz plate on the cover and toward the bottom surface of the substrate to realize a sealed state of the channel. PDMS is a material having weak bonding strength, and removal of this fastening device therefore enabled easy removal of the cover.

A fluorescent IEF marker that enables fluorescence observation of the state of separation was used as the substance that is the object of analysis. The analysis sample was a cIEF gel containing 2% ampholyte carrier (cIEF ampholytes) for establishing a pH gradient in the channel in which voltage is applied, and also containing 2% fluorescent IEF markers.

The analysis sample was first introduced into the cover reservoirs, and the analysis sample was then introduced into the channel using capillary force. After removing the analysis sample that was not able to enter the channel from the cover reservoirs, one cover reservoir was filled with a 0.02M NaOH catholyte (pH 12.4) and the other cover reservoir was filled with 0.1M H₃PO₄ (pH 1.9), and electrodes were inserted into both reservoirs. A voltage of 3.5 kV was then applied for 7 minutes to bring about isoelectric point separation of the IEF marker. The separated state of the IEF marker in the channel was observed using a fluorescence microscope.

The microchip immediately following this observation was cooled using a Peltier stage to freeze the analysis sample and reservoir liquid. It was confirmed by means of fluorescence observation that the separated state of the IEF marker was maintained after freezing.

The electrodes and fastening device were then removed from the microchip while maintaining the frozen state of the analysis sample and reservoir liquid and the cover was removed together with the synthetic quartz plate on the cover. When removing the cover, dry nitrogen was caused to flow continuously toward the microchip such that frost would not adhere to the chip surface. Cracks occurred in the frozen reservoir liquid along the bottom planes of the protruding partitions, following which the frozen reservoir liquid was split between the cover reservoirs and substrate reservoirs and the frozen reservoir liquid inside the cover reservoirs, the frozen reservoir liquid, while adhered to the cover, was removed.

The substrate in which the analysis sample was exposed was next heated for one minute at 60° using the Peltier stage and the solvent of the analysis sample vaporized. Fluorescence observation of the channel confirmed that the separated state of the fluorescent IEF marker was maintained undisturbed even after heating and drying.

The above-described experiment showed that the use of a microchip made up from a cover having convex constructions, which are the partitions, and a substrate provided with column-shaped protruding constructions inside a channel having a zigzag shape, to carry out the analysis steps of: isoelectric point separation of the analysis sample, freezing of the analysis sample, removal of the cover, and heating of the substrate enabled maintenance of the separated state of the analysis sample without change and allowed heating and drying to be carried out in a short time.

### WORKING EXAMPLE 2

The inventors of the present invention used the chip described hereinbelow to carry out an experiment of drying/fixing the analysis sample following isoelectric point separation to show that drying/fixing of an analysis sample can be carried out in a short time while maintaining the separated state without change.

FIG. 10 is a cross-sectional view of cover 102 that was used in Working Example 2 of the present invention.

The substrate of the microchip was a rectangular synthetic quartz substrate measuring 21 mm square, a channel being formed on the upper surface by photolithography and dry etching. The channel was 400 microns wide and 60 mm long and was formed in a zigzag shape. Columnar constructions having a diameter of 10 microns and a pitch of 20 microns were formed uniformly inside the channel, with substrate reservoirs at both ends of the channel.

Cover 102 was a silicone resin (PDMS) 2 mm thick in which through-holes were formed with a diameter of 2 mm at positions corresponding to the substrate reservoirs, these through-holes also serving as cover reservoirs 103. Cover reservoirs 103 included protruding constructions made of PDMS that protruded toward the inner diameters of cover reservoirs 103 as constructions for reducing the areas of the openings of the bottom planes of cover reservoirs 103. Cover 102, cover reservoirs 103, and the constructions for reducing the areas of the openings of the bottom planes of cover reservoirs 103 were made from the same silicone resin and were formed by die-cutting by pressing a knife die against a flat plate of silicone resin and punching (see FIG. 7). The knife die was realized by securing an acute blade in a base plate. A cylindrical knife die for opening holes in parts corresponding to reservoirs was installed. The distinguishing feature of this cylindrical portion is that the diameter of the circle of the tip of the blade is smaller than that of the base of the blade. This shape enabled the formation of cover reservoirs 103 having convex constructions made of PDMS that protrude toward the inner diameters of cover reservoirs 103 as constructions for reducing the areas of the openings of the bottom planes of cover reservoirs 103. In addition, this cover 102 was coated with a hydrophilic polyacrylamide to increase close adhesion between the frozen reservoir liquid and cover 102.

A rectangular synthetic quartz plate having a thickness of 0.5 mm in which through-holes were formed at positions corresponding to cover reservoirs 103 was mounted on cover 102. The microchip was mounted on a Peltier stage having cooling and heating capabilities and analyzed. A fastening device was used to apply pressure from the synthetic quartz plate on cover 102 and toward the bottom surface of the substrate to realize a sealed state of the channel. PDMS is a material having weak bonding strength, and removing the fastening device enables easy removal of cover 102.

A fluorescent IEF marker that allows fluorescence observation of the state of separation was used as the substance that was the object of analysis. The analysis sample was a cIEF gel containing 2% ampholyte carrier (cIEF ampholytes) for establishing a pH gradient in the channel to which voltage is applied, and also containing 2% fluorescent IEF marker.

The analysis sample was first introduced into cover reservoirs 103, following which the analysis sample was introduced into the channel using capillary force. Any analysis sample that was not able to enter the channel was removed from cover reservoirs 103, following which one cover reservoir 103 was filled with 0.02M NaOH catholyte (pH 12.4) and the other cover reservoir 103 was filled with 0.1M H₃PO₄ (pH 1.9), and electrodes were inserted into both reservoirs. Voltage of 3.5 kV was then applied for 7 minutes to bring about isoelectric point separation of the IEF marker, and the state of separation of the IEF marker in the channel was observed using a fluorescence microscope.

Immediately after this observation, the microchip was cooled by using a Peltier stage to freeze the analysis sample and reservoir liquid. Through the use of fluorescence observation, it was confirmed that the separated state of the IEF marker was maintained without change even after freezing. The fastening device was then removed from the microchip while maintaining the frozen state of the analysis sample and reservoir liquid, and the electrodes and cover 102 were removed together with the synthetic quartz plate on cover 102. Cracks occurred in the frozen reservoir liquid along the bottom planes of the partitions of convex shape, and the frozen reservoir liquid was split between cover reservoirs 103 and the substrate reservoirs, and further, the frozen reservoir liquid in cover reservoirs 103 was removed while adhering to cover 102. Removing the electrodes together with the synthetic quartz plate on cover 102 reduced the possibility of shattering the frozen reservoir liquid by the operation of removing the electrodes first and thus reduced the possibility of splitting at a point higher than the bottom plane of the cover reservoirs 103.

Next the substrate in which the analysis sample was exposed was left for three minutes at room temperature using the Peltier stage to vaporize the solvent of the analysis sample. The channel was then observed using fluorescence to confirm that the separated state of the fluorescent IEF marker was maintained without change even after heating and drying.

The above-described experimentation showed the use of a microchip made up from cover 102 having convex constructions, which are the partitions, and a substrate provided with columnar protruding constructions in a channel of zigzag shape, to carry out the analysis steps of: isoelectric point separation of the analysis sample, freezing of the analysis sample, removal of cover 102, and heating of the substrate enabled maintenance of the separated state of the analysis sample without change and further enabled heating and drying in a short time.

1-13. (canceled)

14. A microchip composed of a substrate and a cover; wherein:
said substrate is provided with a trench-shaped channel on its upper surface and substrate reservoirs linked to said channel;
said cover hermetically seals the upper surface of said channel, can be attached to and detached from said substrate, and is provided with: through-holes formed at positions corresponding to said substrate reservoirs, cover reservoirs formed on the inner sides of said through-holes for holding liquid that is introduced when said cover hermetically seals the upper surface of said channel, and partitions formed on the bottom planes of said cover reservoirs; and
the areas of the open portions of said partitions are smaller than the areas of the open portions of said cover reservoirs over said partitions.

15. The microchip according to claim 14, wherein said through-holes also serve as said cover reservoirs.

16. The microchip according to claim 14, wherein said cover reservoirs and said partitions are of the same material.

17. The microchip according to claim 14, wherein said partitions are convex constructions that protrude toward the inside diameters of the cover reservoirs.

18. The microchip according to claim 14, wherein said partitions are films having minute through-holes or voids through which ions can pass.

19. The microchip according to claim 14, wherein protruding constructions that reduce the areas of the surfaces of said partitions that contact said substrate are formed in said substrate reservoirs.

20. The microchip according to claim 14, wherein protruding constructions having hydrophilic surfaces are formed in said channel.

21. The microchip according to claim 20, wherein said protruding constructions in said channel are arranged as rows in the width direction of said channel, and adjacent rows of said protruding constructions are arranged at positions shifted in the width direction of said channel.

22. The microchip according to claim 20, wherein said protruding constructions in said channel are formed such that fluid that moves through said channel moves in a zigzag form.

23. The microchip composed of a substrate and a cover, wherein:
said substrate is provided with a trench-shaped channel on its upper surface and substrate reservoirs linked with said channel;
said cover hermetically seals the upper surface of said channel, can be attached to and detached from said substrate, and is provided with cover reservoirs that are formed at positions corresponding to said substrate reservoirs and that hold liquid introduced when said cover hermetically seals the upper surface of said channel;
said microchip is used for implementing: a separation step of using said microchip to separate an analysis sample, a cooling step of cooling said substrate to freeze the analysis sample and reservoir liquid, and a cover-detaching step of detaching said cover; and
constructions are included on the bottom planes of said cover reservoirs for breaking frozen reservoir liquid at the bottom planes of said cover reservoirs and for detaching the frozen reservoir liquid from said substrate together with said cover in said cover detaching step.

24. A microchip composed of a substrate and a cover, wherein:
said substrate is provided with a trench-shaped channel on its upper surface and substrate reservoirs linked with said channel;
said cover hermetically seals the upper surface of said channel, can be attached to or detached from said substrate, and is provided with through-holes formed at positions corresponding to said substrate reservoirs, and cover reservoirs formed on the inner sides of said through-holes for holding liquid introduced when said cover is in a state of sealing the upper surface of said channel; and
protruding constructions are formed in said substrate reservoirs for reducing the area of surfaces of said partitions that make contact with said substrate.

25. A sample analysis method that uses a microchip according to claim 14, said sample analysis method implementing a series of steps that include:
a cooling step of, after using said channel to separate an analysis sample that includes a substance that is the object of analysis by means of a desired process such as electrophoresis, cooling said substrate to attain a prescribed low temperature condition that is the freezing point of the analysis sample or lower to implement an operation for freezing the analysis sample and reservoir liquid that are held in said channel and for which separation has been completed by a process such as electrophoresis;
a cover-detaching step of implementing an operation to detach and remove the cover from the substrate by: while maintaining a state in which said substrate is kept cooled to said prescribed low temperature to keep the analysis sample that has undergone separation by a process such as electrophoresis in a frozen state, placing the upper surface of said substrate and the lower surface of said cover in close contact to withdraw reservoir liquid, which is adhered in said channel, and moreover, which is frozen inside said cover reservoirs, from inside said channel while still adhered to said cover; and applying an external force to the end of said cover to detach the lower surface of said cover from the upper surface of said substrate to implement an operation for releasing the bonding force that achieves a bonded state in a prescribed arrangement; and
a heating step of, after completing said detaching step, implementing an operation upon the analysis sample that has undergone a separation process such as electrophoresis and that is held inside the channel and moreover that is exposed wherein said substrate is heated to dry solvent that is contained.

26. The sample analysis method according to claim 25, wherein the cover-detaching step is a step of implementing an operation for detaching and removing said cover from said substrate in a dry gas atmosphere.
